(19) United States
(12) Patent Application Publication
(10) Pub. No.: US 2014/0158801 A1
(43) Pub. Date: Jun. 12, 2014

(54) CRUSHING ROLLER

(71) Applicants: Jason Euculano, Bethlehem, PA (US); Raymond M. Burynski, New Hartford, NY (US)

(72) Inventors: Jason Euculano, Bethlehem, PA (US); Raymond M. Burynski, New Hartford, NY (US)

(73) Assignee: FLSMIDTH A/S, Valby (DK)

(21) Appl. No.: 14/000,751

(22) PCT Filed: Feb. 10, 2012
(86) PCT No.: PCT/US12/24576

§ 371 Date: Aug. 21, 2013

Related U.S. Application Data
(60) Provisional application No. 61/445,584, filed on Feb. 23, 2011.

(51) Int. Cl. B02C 4/30

(52) U.S. Cl. CPC B02C 4/305
USPC 241/294; 29/895.21

(57) ABSTRACT

Described is a roller for crushing of particulate material, such as crude ore for use in the mineral industry, where the roller body is provided with a roller shell having a plurality of individual wear segments. The roller shell is characterized in that adjacent wear segments have complementary sides and in that a number of the wear segments, prior to mounting of the remaining wear segments, are initially fixed to the roller body in order to provide guiding and fixation for the remaining wear segments which are wedged-in between the number of initially fixed wear segments.

The present invention relates to a roller for the crushing of particulate material, such as crude ore for use in the cement or minerals industries, by which a roller body is provided with a roller shell comprising a plurality of individual wear segments that are wedged together in such a manner to minimize or eliminate the gaps between the segments. The invention also relates to a method of manufacturing said roller.

The roller may for example be used 1) in a high-pressure grinding roller press, 2) in a vertical roller mill, 3) or in similar equipment for crushing of particulate material.

### BACKGROUND OF THE INVENTION

Segmented crushing rollers are known from DE 197 09 263 A1, U.S. Pat. No. 5,253,816, and U.S. Pat. No. 5,860,609. These patents/applications describe rollers having the outer circumference of the roller body covered with a segmented roller shell; however, such a segmented solution is not typically used in high pressure grinding applications. This is because in high-pressure applications, the pressure is extraordinarily high and can result in the crushing surface of the rollers being being comminuted to be forced into the gaps between the segments. After prolonged and repeated exposure to these loads, a pressure build-up between neighboring segments will promote movement of the segments. Initially such movements will be small but after a period of time the movements will become significant and may eventually result in damage to the segments, the clamps, the roller surface, or even the roller body. As a consequence hereof, such segments, clamps, roller surfaces or roller body must be repaired meaning that the entire grinding circuit often must be taken out of operation, which is very costly. Therefore, in such high pressure grinding applications, a single, complete grinding surface is used (see U.S. Pat. No. 5,269,477). However, a segmented solution would be advantageous for high pressure grinding applications since the smaller segments are easier to manufacture and to install. In addition, in the event one part of the roller surface fails, only the affected segment(s) would need to be replaced, rather than the entire single, complete grinding surface.

As an example of prior does that do not work in high pressure applications, German reference DE 197 09 263 A1 shows segments and the roller body that are each provided with laterally protruding means on which clamps are engaged for securing the segments to the roller body. Neighboring segments have a clearance of up to 8 mm due to casting tolerance of the individual segments thereby forming the aforementioned gaps in the circumferential direction between the segments. The configuration of the segments disclosed in the German application will allow significant crushed material to be introduced and compacted in these gaps between the segments. In high pressure applications, the condition will result in a pressure build-up between neighboring segments and ultimately cause premature failure of the segments, clamps, roller surface or roller body.

### SUMMARY OF INVENTION

It is an object of the present invention to provide a segmented crushing roller suited for high pressure applications by means of which the described disadvantages with gaps between adjoining segments are minimized or eliminated. This is obtained by a roller of the kind mentioned in the introduction, and being further characterized in that the wear segments have two ends and have two sides, where the sides of adjoining wear segments are complementary. After the first wear segment is affixed to the roller body, each additional wear segment is affixed to the roller body and mechanically tightened in the axial direction as to minimize or eliminate the gap between adjoining wear segments. This process is repeated until the entire roller body is covered by tightened wear segments. Due to the minimization and/or absence of gaps, a pressure build-up between the segments is avoided resulting in increased service life of the segmented crushing roller. A further advantage is that the wear segments support each other on the outer circumference of the roller body resulting in a rigid roller shell. A tongue and groove arrangement on the adjoining sides of the wear segments may also be used to further secure the wear segments.

In another embodiment, a number of the wear segments, prior to mounting the remaining wear segments, are initially fixed to the roller body by a fastening means in such a manner that spaces are formed between each initially fixed wear segment. Each of the remaining wear segments, said wear segments having non-parallel sides, is then wedged-in to the corresponding space between initially fixed wear segments by a tightening means until the gap between the adjoining sides of the initially fixed wear segments and the wedged-in wear segment is minimized or eliminated. The wedged-in segment(s) are then securely affixed to the roller body using a fastening means.

It is preferred that each of the wear segments are trapezoidal in shape (although any shape with non-parallel sides can be used), with each segment having a pair of substantially parallel ends (these ends form the outer edges of the crushing surface), one end being a wide end and the other a narrow end, and a pair of non-parallel sides. The non-parallel sides of adjoining wear segments are adjacent, co-axial and complementary to each other. The wedged-in wear segments are then wedged-in between the initially fixed wear segments ensuring close contact along the adjoining sides of adjoining segments. Both the initially fixed wear segments and the wedged-in wear segments are, when located on the roller body, symmetrical about a vertical plane extending through the axial centre axis of the roller body. The wear segments which are initially fixed and wedged-in, respectively, are arranged alternately around the roller body with the adjoining wear segments being rotated 180° from each other. In this way, identical wear segments may be used resulting in reduced costs since only one type of wear segment has to be manufactured, mounted and kept as spare parts.

In a preferred embodiment the wear segments, both the initially fixed wear segments and the wedged-in wear segments are provided with a fastening means, in particular axially projecting lugs provided on each end of the wear segments. These lugs and mating projecting rings provided on each end of the roller body are engaged by a clamping means arranged on both ends of the roller. An axial arranged screw connection will tighten the clamping means and fix each end (both the wide end and narrow end) of the wear segments to the roller body. Other ways of fixing the wear segments to the roller body are within the scope of this invention. For example the wear segments may be fixed to the roller by means of a binding ring, shrink ring, welding, or by means of radially arranged screws.

In an alternate embodiment, both the initially fixed wear segments and the wedged-in wear segments may be arranged on guiding means which are fixed to or cast into the roller body prior to fixing any of the wear segments to the roller body. The guiding means on which the initially fixed wear segments are affixed may comprise of one or more end stops to ensure accuracy of the axial location of the initially fixed wear segments. Furthermore these guiding means may comprise one or more tightening means opposite the end stop for forcing the wear segments against the end stop. When located axially, the wear segments are then fixed to the roller body by the clamping means. The guiding means for the wedged-in wear segments, which prior to wedging are placed on the guiding means, are located between the initially fixed segments.

The wedged-in wear segments may have tightening means for performing the wedging-in of the wedged-in wear segments and prevents the wedged-in wear segments from moving in the axial direction once affixed to the roller body. In principle the tightening means may comprise all kinds of force mechanisms as long as they have the capability to wedge-in the wedged-in wear segments and prevent axial movement. For example, the force for the tightening means may originate from a design utilizing hydraulics. However, it is preferred that screws deliver the force for wedging-in the wedged-in wear segments as this is a simple and low-cost solution. The guiding means for the wedged-in wear segments may not have an end stop as the tightening means are tightened until each non-parallel side of the wedge-shaped wear segments has completely contacted the corresponding adjoining sides of the adjoining initially fixed wear segments thereby minimizing or completely eliminating any gaps.

In a further embodiment at least one of the wear segments is provided with a plurality of inserts which are embedded or are protruding from the crushing surface of the wear segment. The inserts often will be made of harder material than the material of the wear segments. In principle the inserts may have all kind of shapes, however, it is preferred that they are pin-shaped. Moreover, it is preferred that all of the wear segments are provided with inserts and that the inserts have a layout promoting relatively even spacing between the inserts, with each spacing being eventually filled with crushed material during operation. The effect obtained by this is referred to as autogenous wear protection since the crushed material retained between the inserts acts as wear protection for the underlying roller shell. The autogeneous layer builds up naturally during operation, but may be further enforced by the favorable layout and shapes of the inserts.

In yet a further embodiment, at least one of the wear segments is provided with hardfacing on the crushing surface. The hardfacing protects the entire wear segment surface.

Further features of the invention are the subject matter of subordinate claims and are explained in greater detail in connection with the following description of some embodiments.

### DESCRIPTION OF THE DRAWINGS

The invention will now be explained in further details with reference to the drawing, being diagrammatical, and where:

FIG. 1 shows a three-dimensional model of a roller according to the preferred embodiment of the invention,

FIG. 2a and FIG. 2b show a cross-sectional view of an initially fixed wear segment and a wedged-in wear segment, respectively, and

FIG. 3 shows a wear segment according to the invention.

FIG. 4 shows a preferred arrangement for wear-resistant inserts.

FIG. 5a shows a preferred arrangement to divide the wear-resistant inserts into regions on a wear segment that is too wide for a single arrangement so that the inserts are more evenly spaced. This figure illustrates the convergence point from inserts in region 1.

FIG. 5b shows a preferred arrangement to divide the wear-resistant inserts into regions on a wear segment that is too wide for a single arrangement so that the inserts are more evenly spaced. This figure illustrates the convergence point from inserts in region 2.

FIG. 5c shows a preferred arrangement to divide the wear-resistant inserts into regions on a wear segment that is too wide for a single arrangement so that the inserts are more evenly spaced. This figure illustrates the convergence point from inserts in region 3.

### DETAILED DESCRIPTION OF INVENTION

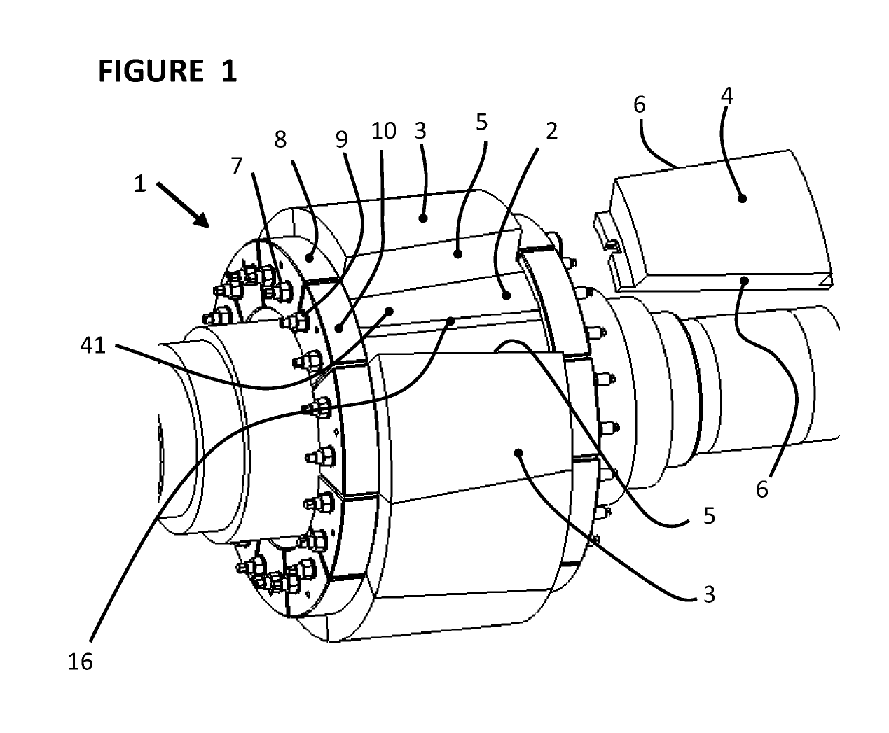

FIG. 1 shows a three-dimensional model of the preferred embodiment where a roller 1 where the outer circumference of a roller body 2 is provided with a roller shell having a plurality of individual wear segments 3, 4. The wear segments 3, 4 are trapezoidal in shape and, in the preferred embodiment, identical and, in their placement on the roller shell, rotated 180° from adjacent wear segments. Segments 3, 4 are arranged adjacent to each other on the roller body 2 for providing fixation in the circumferential direction. The non-parallel sides 5 of the initially fixed wear segment 3 and the non-parallel sides 6 of each adjacent wedged-in wear segment 4 are complementary to each other. When assembled, a number of wear segments 3 are initially fixed to the roller body 2 by fastening means in the form of screw connections 7 and clamps 8. By initially fixing the wear segments 3 in this manner, a series of spaces 41 are created between them. Initially attaching the wear segments 3 to the roller body provides guiding for the remaining wear segments 4, which are wedged-in to the spaces 41 that were created between the initially fixed wear segments 3. In this way the roller shell has alternately initially fixed wear segments 3 and wedged-in wear segments 4 which, once tightened, minimizes or eliminates gaps between the wear segments 3, 4. Besides the fixation in the circumferential direction of the wedged-in wear segments 4, these wear segments 4 are also fixed to the roller body 2 by fastening means in the form of screw connections 9 and clamps 10. The roller body 2 may also have one or more guiding means 16 on which the wedge segments 3, 4 can be aligned and affixed.

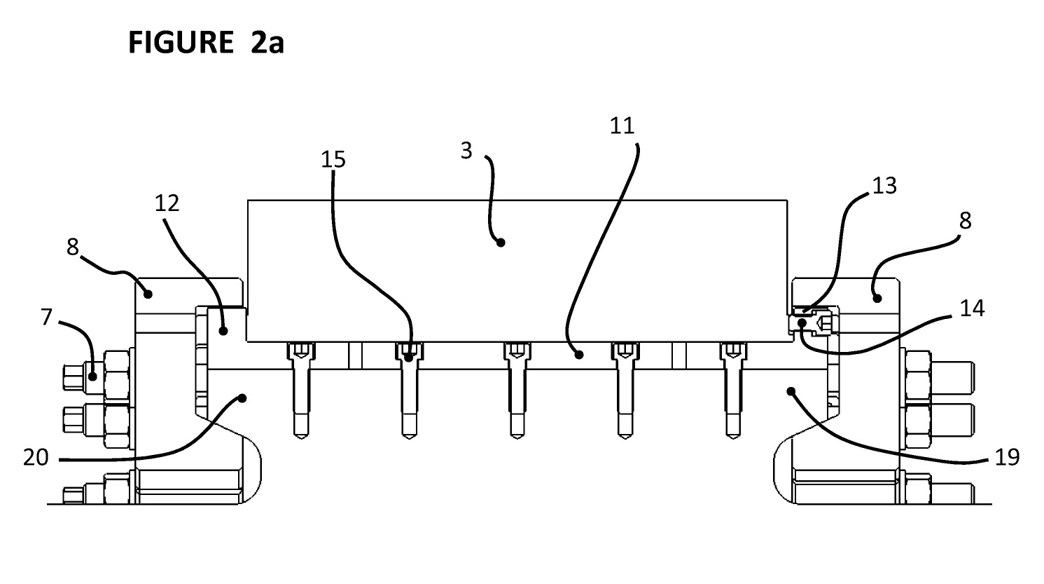

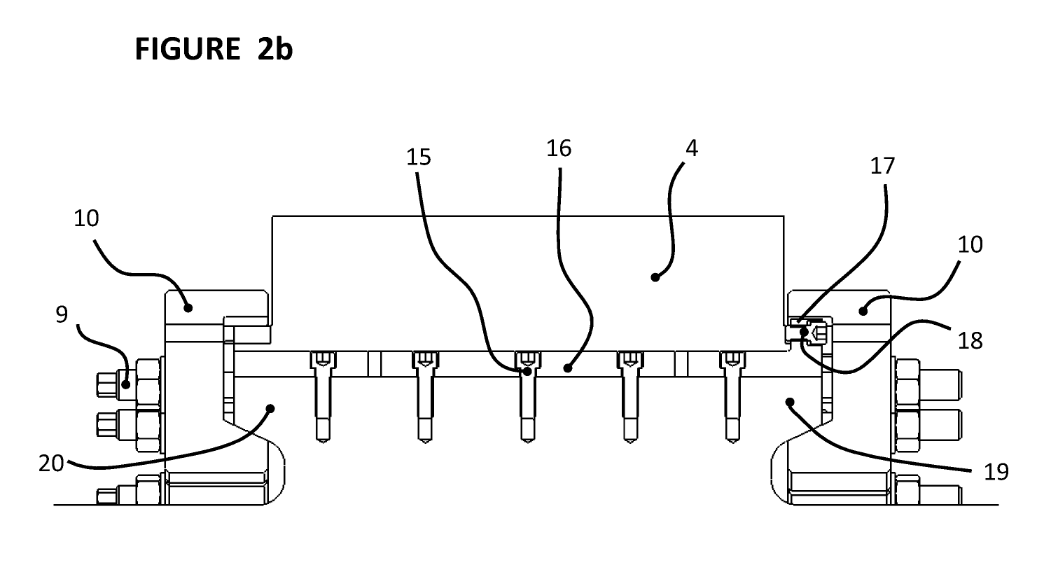

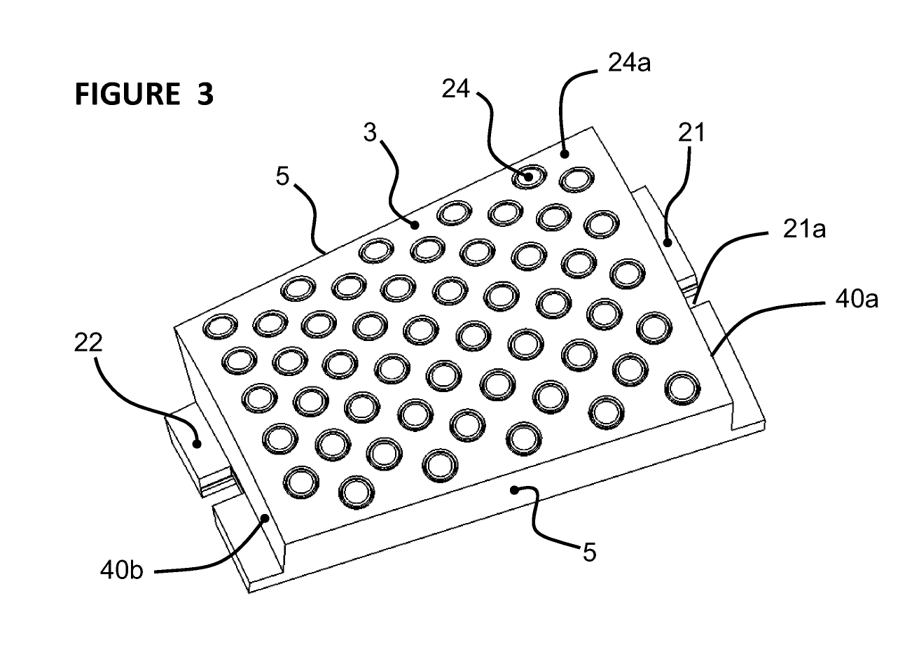

FIG. 2a and FIG. 2b show, respectively, a cross-sectional view of an initially fixed wear segment 3 and a cross-sectional view of a wedged-in wear segment 4, respectively. In both figures of this preferred embodiment of the roller 1, the wear segments 3, 4 are arranged on guiding means 11,16 which are fitted and fixed to the roller body 2 by a fastening means, in this case radially located screws 15, prior to fixing any of the wear segments 3, 4 to the roller body 2. The guiding means 11 for the initially fixed wear segments 3 (FIG. 2a) have an upturned edge 12, 13 in both ends of its axial direction. Each initially fixed wear segment 3 is placed on a guiding means 11 after which a screw 14 located axially in a threaded hole in one of the upturned edges 13 is tightened until the wear segment 3 is forced against the other upturned edge 12 to ensure an exact axial location of the initially fixed wear segment 3. When all the wear segments 3 are in place they are fixed to the roller body by the screw connections 7 and the clamps 8. Each wedged-in wear segment 4 to be wedged-in (FIG. 2b) between the initially fixed wear segments 3 is placed on a guiding means 16 which has only one upturned edge 17 wherein a screw 18 is mounted axially in a threaded hole. When the screw 18 is tightened, the wear segment 4 is forced to move in the axial direction until the adjoining non-parallel sides 5 of the adjacent initially fixed wear segments 3 provide a stop from further movement. Both the initially fixed wear segments 3 and the wedged-in wear segments 4 are provided with axially projecting lugs 21, 22 (see FIG. 3) provided on each end of the segments 3, 4. These lugs 21, 22 and mating projecting rings 19, 20 protruding from each side of the roller body 2 are engaged by clamps 8, 10 arranged on both sides of the roller 1. The axially arranged screw connections 7, 9 tighten the clamps 8, 10 and fix the wear segments 3, 4 to the roller body 2. The inner sides of the projecting rings 19, 20 provided on the roller are inclined in order to increase the clamping force when the axial arranged screw connections 7, 9 are tightened.

FIG. 3 shows the preferred embodiment of the wear segment 3 with non-parallel sides 5. Both sides 5 have an inclination from the same end of the wear segment 3 towards the other end so as to form a trapezoidal wear segment having a parallel wide end 40a and narrow end 40b. In the preferred embodiment, the wear segment 3 and the wedged-in wear segment 4 are identical and are rotated 180° from each other when fixed to roller body 2, so that when all the wear segments are in place according to the invention, the wide end 40a and narrow end 40b are alternatively placed around the outer surface of each end, or outer periphery, of the crushing surface of the roller.

The wear segments are considered to be “wedge-shaped” in the sense that if each non-parallel side 5, in the case of segment 3 (or each non-parallel side 6, in the case of segment 4) of the wear segment is extended beyond the narrow end 40b said sides will eventually converge.

The underside of the wear segment 3 is curved to fit the curvature of the roller body 2. The underside of the wear segment 3 may also have a channel 21 a that will align with the guiding means 11, 16 (See FIGS. 2a and 2b). The crushing surface 24a of the wear segment 3 may be hard-faced to increase the service life of the wear segment 3. In the preferred embodiment, the wear segment 3 is provided with inserts 24 which are embedded into the crushing surface. During operation the spaces between the inserts 24 are filled with crushed material whereby an autogenous wear protection is created. It is preferred that the inserts 24 are evenly distributed on the crushing surface of the wear segment and are made of a harder material than that of the remainder of the crushing surface 24a.

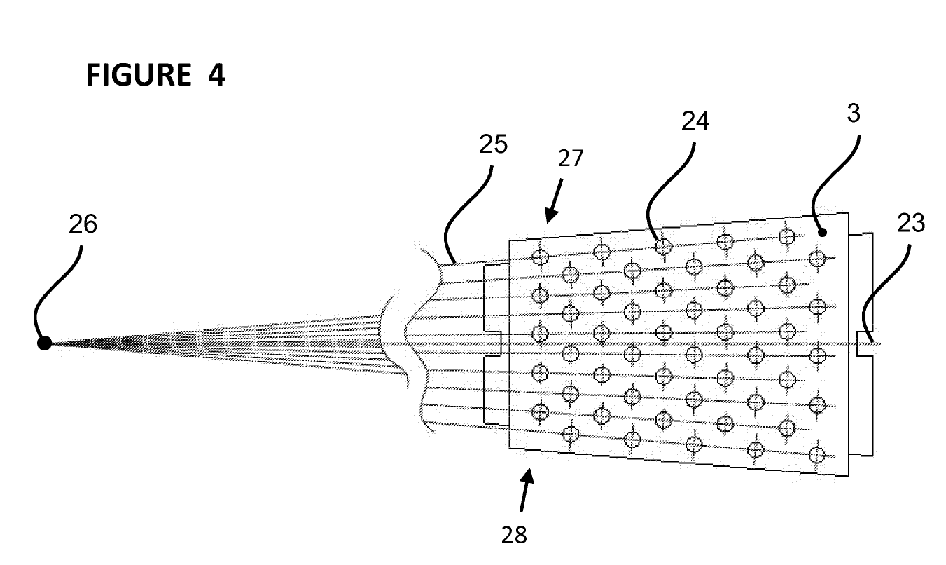

FIG. 4 shows the wear segment 3 (or wear segment 4) provided with inserts 24 which are embedded in the crushing surface 24a according to a preferred arrangement. Due to the trapezoidal shape of wear segment 3, this preferred arrangement consists of inserts 24 being spaced on placement lines 25 which, if extended beyond the surface of wear segment 3, would converge at a common point 26. In the presence of an adjacent wear segment, the preferred arrangement of inserts 24 shown at the side regions 27, 28 is not symmetrical about center axis 23.

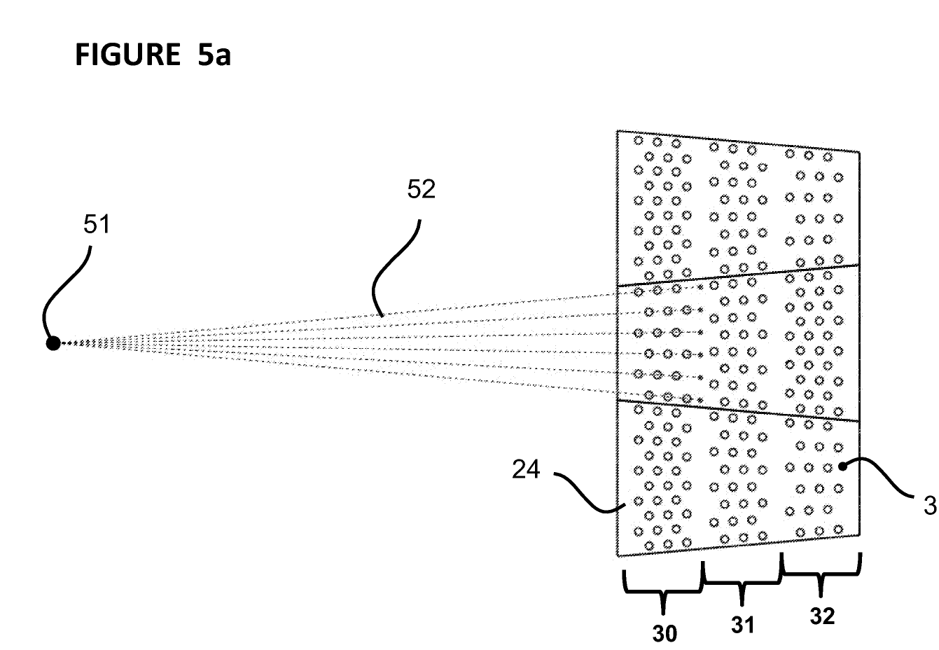

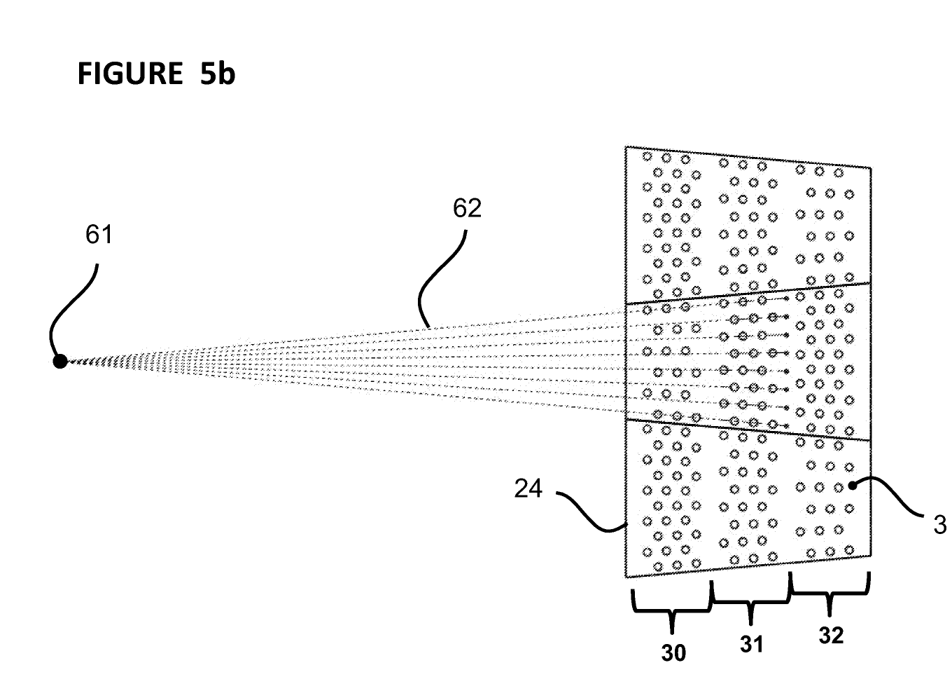

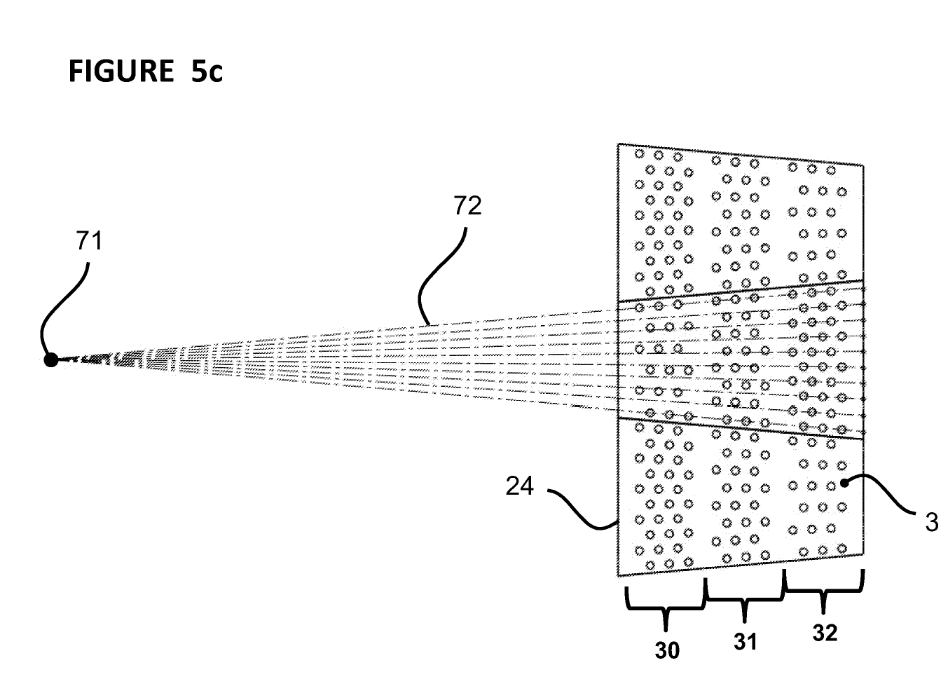

FIGS. 5a through 5c show the wear segment 3 provided with inserts 24 which are embedded in the crushing surface 24a according to a preferred arrangement. FIGS. 5a through 5c differ from FIG. 4 in that the wear segment 3 is too wide for a single arrangement of inserts 24. Rather the wear segment is divided into axial regions 30, 31, 32. Each region's placement lines 52, 62, 72 can have its own convergence point 51, 61, 71, respectively. In this way, the inserts 24 are all relatively evenly spaced in the wear segments 3, 4.

It is to be understood that the form of this invention as shown is merely a preferred embodiment. Various changes may be made in the function and arrangement of parts; equivalent means may be substituted for those illustrated and described; and certain features may be used independently from others without departing from the spirit and scope of the invention as defined in the following claims.

1. A roller for crushing particulate material comprising:
a roller body having a centre axis;
a plurality of wear segments, having crushing surfaces, that are fixed to said roller body in a manner that forms a plurality of spaces between said fixed wear segments;
a plurality of wear segments, having crushing surfaces and non-parallel sides, when viewing said crushing surfaces in a direction perpendicular to said centre axis, that are wedged-in said spaces and fixed to said roller body wherein at least one of said wedged-in wear segments is oriented substantially 180° from at least one of (i) said fixed wear segments or (ii) said wedged-in wear segments.

2. A roller for crushing particulate material as in claim 1 wherein said fixed wear segments have non-parallel sides when viewing said crushing surfaces in a direction perpendicular with said centre axis.

3. A roller for crushing particulate material as in claim 2 wherein said fixed wear segments and said wedged-in wear segments are both trapezoidal in shape when viewing said crushing surfaces in a direction perpendicular with said centre axis.

4. A roller for crushing particulate material as in claim 2 wherein said wedged-in wear segments are identical to said fixed wear segments.

5. A roller for crushing particulate material as in claim 3 wherein said fixed wear segments having a wide end and a narrow end and said wedged-in wear segments having a wide end and a narrow end are arranged alternately around said roller body 180° from adjoining wear segments such that the narrow end of each of said fixed wear segments is adjacent to the wide end of each of the adjoining wedged-in wear segments.

6. A roller for crushing particulate material as in claim 1 wherein the said wear segments are arranged on a guiding means, said guiding means being fixed to said roller body.

7. A roller for crushing particulate material as in claim 1 wherein at least one of said wear segments is hardfaced.

8. A roller for crushing particulate material as in claim 1 wherein at least one of said wear segments is provided with a plurality of inserts which are made of a harder material than that of the said wear segments.

9. A roller for crushing particulate material as in claim 8 wherein said inserts are located along a plurality of placement lines, said placement lines converging at a common point.

10. A roller for crushing particulate material as in claim 8 wherein said wear segment is divided into two or more axial regions, said axial regions having inserts, which are located along a plurality of placement lines which converge to at least one common point.

11. A method for manufacturing a roller for crushing of particulate material, comprising the steps of:
fixing a plurality of wear segments, having crushing surfaces, to a roller body, having a centre axis, in a manner that provides for a plurality of spaces between said fixed wear segments;
wedging-in a plurality of wear segments, said wedged-in wear segments having crushing surfaces and non-parallel sides, when viewing said crushing surfaces in a direction perpendicular with said centre axis, in said spaces between said fixed wear segments whereby all said spaces are filled with said wedged-in wear segments wherein at least one of said wedged-in wear segments is oriented substantially 180° from at least one of (i) said fixed wear segments or (ii) said wedged-in wear segments;

12. A method for manufacturing a roller as in claim 11 wherein said fixed wear segments and said wedged-in wear segments are both trapezoidal in shape when viewing said crushing surfaces in a direction perpendicular with said centre axis;

13. A method for manufacturing a roller as in claim 12 wherein said wedged-in wear segments are identical to said fixed wear segments;

14. A method for manufacturing a roller as in claim 12 wherein said fixed wear segments having a wide end and a narrow end and said wedged-in wear segments having a wide end and a narrow end, respectively, are arranged alternately 180° from each other around said roller body such that the narrow end of each of the fixed wear segments is adjacent to the wide end of each of the adjoining wedged-in wear segments.

15. A method for manufacturing a roller as in claim 11 wherein at least one of said wear segments is provided a plurality of inserts, said inserts being made of a harder material than said wear segment.

16. A method for manufacturing a roller as in claim 15 wherein said inserts are located along a plurality of placement lines, said placement lines converging at a common point.

17. A method for manufacturing a roller as in claim 15 wherein said wear segment is divided into two or more axial regions, said axial region having inserts, which are located along a plurality of placement lines which converge to a common point.

18. A method for manufacturing a roller as in claim 15 wherein the wear segment is divided into two or more axial regions, said axial region having inserts, which are located along a plurality of placement lines which converge to a common point, said common point being specific to each said axial region.

19. A method for manufacturing a roller for crushing of particulate material, comprising the steps of:
affixing a plurality of wear segments to a roller body having a centre axis, said wear segments having crushing surfaces and non-parallel sides when viewing said crushing surfaces in a direction perpendicular with said centre axis;
tightening of at least one said wear segment in a direction substantially parallel with said centre axis where at least one of its sides is flush with a side of an adjoining wear segment.
